(19) United States
(12) Patent Application Publication
(10) Pub. No.: US 2009/0278691 A1
(43) Pub. Date: Nov. 12, 2009

(54) Security device having a hooking element

(75) Inventor: Franklin H. Valade, Fort Walton Beach, FL (US)

Correspondence Address: Tyco International LTD, Ip Legal Department, One Town Center Road, BOCA RATON, FL, 33486, US

(73) Assignee: Sensormatic Electronics Corporation, Boca Raton, FL (US)

(21) Appl. No.: 11/920,943

(22) PCT Filed: May 22, 2006
(86) PCT No.: PCT/US2006/019860

§ 371 Date: May 12, 2009

Related U.S. Application Data
(60) Provisional application No. 60/683,657, filed on May 23, 2005.

(51) Int. Cl. G08B 13/14

(52) U.S. Cl. 340/572.8

(57) ABSTRACT

A security device (102) for an article, comprising a security tag, a locking mechanism, a locking element (186) and a housing (130) comprising means for securing the security tag, locking mechanism and locking element thereto.

This application claims priority to the U.S. Provisional Patent Application Ser. No. 60/683,657 titled “Improved EAS Security Tags” filed May 23, 2005, which is incorporated herein by reference in its entirety.

### BACKGROUND

A security tag system is designed to prevent unauthorized removal of an item from a controlled area. For example, a typical Electronic Article Surveillance (EAS) system may comprise a monitoring system and one or more security tags. The monitoring system may create a surveillance zone at an access point for the controlled area. A security tag may be enclosed in a security device that is secured to the monitored item, such as an article of hard goods, e.g., sporting equipment, eye wear, jewelry, bottles, and the like. If the monitored item enters the surveillance zone, an alarm may be triggered to indicate unauthorized removal.

The security device may be secured to a number of different items. It may be desirable for the security device to allow authorized release from the article, while making unauthorized release relatively difficult. Consequently, there may be a need for improved techniques in security devices in general, and systems for securing the security devices to articles in particular.

### BRIEF DESCRIPTION OF THE DRAWINGS

The subject matter regarded as embodiments is particularly pointed out and distinctly claimed in the concluding portion of the specification. Embodiments, however, both as to organization and method of operation, may best be understood by reference to the following detailed description when read with the accompanying drawings in which:

FIG. 1 illustrates components of a security device and system, in accordance with one embodiment;

FIG. 1A illustrates a perspective view of a detacher, in accordance with one embodiment;

FIG. 1B illustrates a top view of a detacher, in accordance with one embodiment;

FIG. 1C illustrates a front view of a detacher, in accordance with one embodiment;

FIG. 1D illustrates a side view of a detacher, in accordance with one embodiment;

FIG. 1E illustrates a perspective view of a portion of a security device configured for one-time use;

FIG. 1F illustrates a top view of a portion of a security device configured for one-time use;

FIG. 1G illustrates a perspective view of a portion of a security device configured to be resettable;

FIG. 1H illustrates a perspective view of a portion of a security device configured to be resettable;

FIG. 1I illustrates a top view of a portion of a security device configured to be resettable;

FIG. 1J illustrates a front view of a portion of a security device configured to be resettable;

FIG. 2 illustrates a perspective view of a hook tag security device, in accordance with one embodiment;

FIG. 3 illustrates a perspective view of a hook tag security device, in accordance with one embodiment;

FIG. 4 illustrates a perspective view of a hook tag security device, in accordance with one embodiment;

FIG. 5 illustrates a perspective view of a hook tag security device, in accordance with one embodiment;

FIG. 6 illustrates a perspective view of a hook tag security device, in accordance with one embodiment;

FIG. 7 illustrates a perspective view of a hook tag security device, in accordance with one embodiment;

FIG. 8 illustrates a top view of a hook tag security device except for a hooking element, in accordance with one embodiment;

FIG. 9 illustrates a front view of a hook tag security device except for a hooking element, in accordance with one embodiment;

FIG. 10 illustrates a right side view of a hook tag security device except for a hooking element, in accordance with one embodiment;

FIG. 11 illustrates a top view of a hook tag security device, in accordance with one embodiment;

FIG. 12 illustrates a front view of a hook tag security device, in accordance with one embodiment;

FIG. 13 illustrates a right side view of a hook tag security device, in accordance with one embodiment;

FIG. 14 illustrates a left side view of a hook tag security device, in accordance with one embodiment;

FIG. 15 illustrates an exploded view of a hook tag security device, in accordance with one embodiment;

FIG. 16 illustrates a perspective view of a locking mechanism, hooking element, and a lower housing of a hook tag security device, in accordance with one embodiment;

FIG. 17 illustrates a perspective view of a locking mechanism, hooking element, and a lower housing of a hook tag security device, in accordance with one embodiment;

FIG. 18 illustrates a front view of a locking mechanism, hooking element, and a lower housing of a hook tag security device, in accordance with one embodiment;

FIG. 19 illustrates a front view of a locking mechanism, hooking element, and a portion of a lower housing of a hook tag security device, in accordance with one embodiment;

FIG. 20 illustrates a perspective view of a hook tag security device with a pair of eyeglasses secured thereto, in accordance with one embodiment;

FIG. 21A illustrates a perspective view of a hook tag security device with a shoe secured thereto, in accordance with one embodiment;

FIG. 21B illustrates another perspective view of a hook tag security device with a shoe secured thereto, in accordance with one embodiment

FIG. 22 illustrates a perspective view of a hook tag security device with a piece of jewelry secured thereto, in accordance with one embodiment;

FIG. 23 illustrates a perspective view of a hook tag security device with a ring secured thereto, in accordance with one embodiment;

FIG. 24A illustrates a perspective view of a hook tag security device with a fishing rod and reel secured thereto, in accordance with one embodiment; and

FIG. 24B illustrates another perspective view of a hook tag security device with a fishing rod and reel secured thereto, in accordance with one embodiment.

### DETAILED DESCRIPTION

Embodiments may be directed to apparatuses, systems and methods for pairing article, such as a piece of sporting equipment, eye wear, or jewelry, for example, with a security tag.

For example, one embodiment may include a security device comprising a locking mechanism, security tag, and a housing. The locking mechanism may comprise a magnetically actuable latch, a flexible element that biases the magnetically actuable latch toward a locking position, and a latch mating element that mates with at least a portion of the magnetically actuable latch in the locking position. As used herein, the “locking position” may refer to the position of the magnetically actuable latch in which it is partially or fully within a void of, in engagement with, joined with, or otherwise mated with the latch mating element. The housing may be a structure configured to partially or fully contain, enclose, or otherwise secure the locking mechanism, security tag, latch mating element, and the article to the housing. As secured, the magnetically actuable latch of the locking mechanism may mate with the latch mating element in the locking position to lock the housing, and thus the security tag with which the housing is secured, to the article. When the housing is locked, the security device may prevent or provide resistance to an attempt to separate the housing from the article. Another embodiment may include a security system comprising the security device and a detacher, which may be a device that includes a magnet. The detacher may be employed to unlock the housing by magnetically forcing the magnetically actuable latch away from the locking position. It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Numerous specific details may be set forth herein to provide a thorough understanding of the embodiments. It will be understood by those skilled in the art, however, that the embodiments may be practiced without these specific details. In other instances, well-known methods, procedures and components have not been described in detail so as not to obscure the embodiments. It can be appreciated that the specific structural and functional details disclosed herein may be representative and do not necessarily limit the scope of the embodiments.

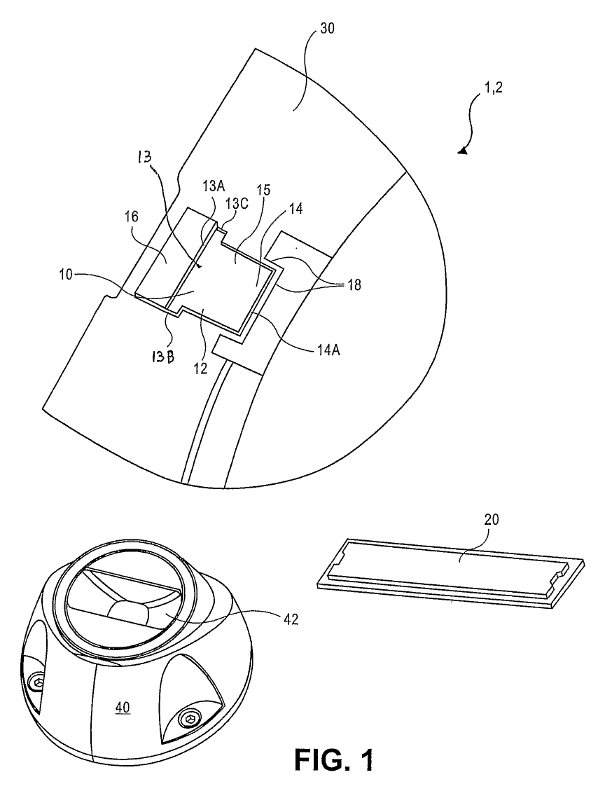

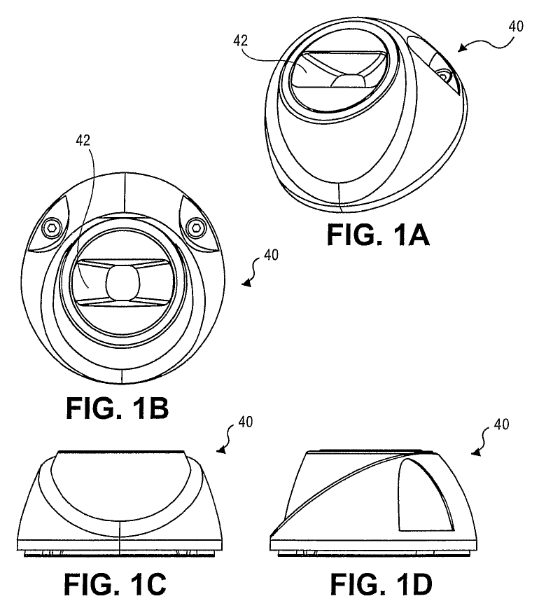

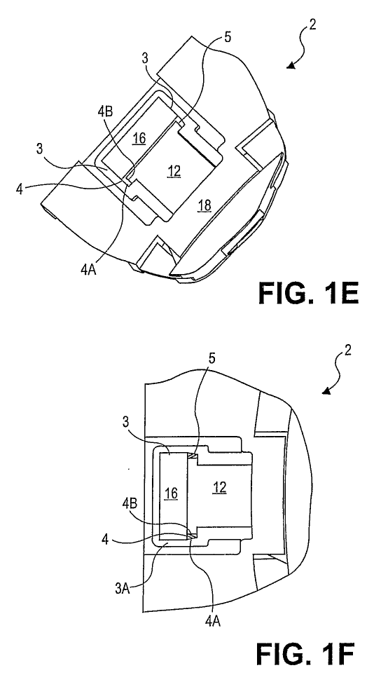

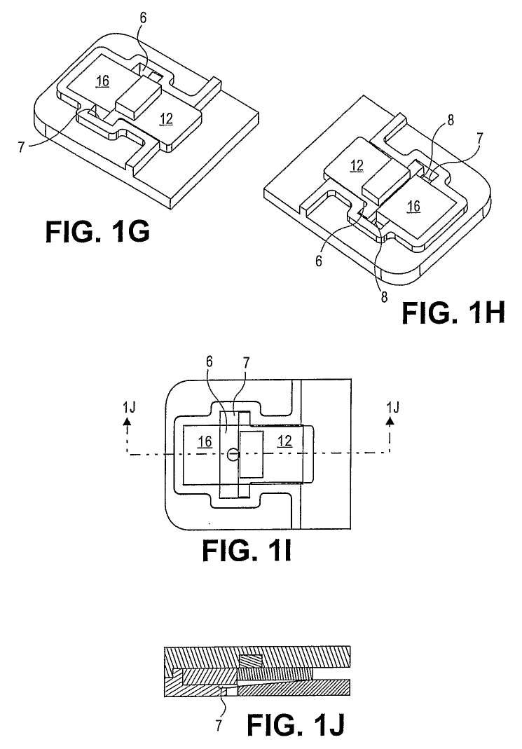

Referring now in detail to the drawings wherein like parts are designated by like reference numerals throughout, there is illustrated in FIG. 1 a front view of components that may be included in a security system 1 and a security device 2 in accordance with one embodiment. In this embodiment, the security system 1 includes the security device 2 and a detacher 40. The security device 2 may include a locking mechanism 10, security tag 20, and housing 30.

The locking mechanism 10 may be a magnetically actuable locking mechanism, and may include a magnetically actuable latch 12, flexible element 16, and latch mating element 18.

The magnetically actuable latch 12 may include a base portion 13, which may include a base portion end 13A and side surfaces 13B and 13C; and a latching portion 14, which may include a latching portion end 14A; and a central portion 15.

The magnetically actuable latch 12 may have a substantially rectangular-shaped face such that the base portion 13 has the same width as both the latching portion 14 and central portion 15. Thus, the width of the base portion 13, or the distance between the side surfaces 13B and 13C, may be the same as the corresponding widths of the latching portion 14 and central portion 15. In other embodiments, the widths of the base portion 13, latching portion 14, and central portion 15 may differ. The magnetically actuable latch 12 may have a slender, uniform cross-section.

However, the magnetically actuable latch 12 may be configured as desired, may comprise one or more pieces, and may be symmetrical or unsymmetrical about any point, line, or plane. For example, in various embodiments the magnetically actuable latch 12 may be configured with a “T”, “I”, curved, or other shape of face and with a rectangular, circular, thick, hollow or otherwise voided, and/or non-uniform cross-section, or as described herein with respect to embodiments of the magnetically actuable latch 112. In another embodiment, the latching portion end 14A of the magnetically actuable latch 12 may include one or more teeth, ribs, notches, jags, points, curves, voids, or other shapes such as those described herein with respect to embodiments of the magnetically actuable latch 112, while the base portion end 13A may be flat or another shape. In addition, the base portion end 13A may be continuous or discontinuous. The magnetically actuable latch 12 may be configured such that at least a portion of it, such as the latching portion 14, may engage, receive, insert into, or otherwise mate with the latch mating element 18, such as described herein.

In one embodiment, a security device 2 includes multiple magnetically actuable latches 12, which may be disposed, possibly each along with another flexible element 16 and latch mating element 18, in the same or different portions of the security device 2. For example, in one embodiment, the multiple magnetically actuable latches 12 may each cooperate with another portion of the security device 2 to lock the portion, such as, for example, a portion securing an article or a portion securing a security tag 20.

The magnetically actuable latch 12 may comprise or may be formed of a magnetic material such as iron, nickel, or cobalt, or an alloy of iron, nickel, or cobalt. In one embodiment, the magnetically actuable latch 12 includes one or more magnetic materials and may also include one or more nonmagnetic materials.

The flexible element 16 may be shaped as desired, such as in a cuboid, ellipsoid, coil, or any other shape such as described herein, and may include one or more pieces, or may be combined or integrally formed with the magnetically actuable latch 12. In one embodiment, the flexible element 16 may be shaped as a cantilever arm, such as, for example, a leaf spring. The flexible element 16 may comprise or may be formed of a flexible material such as a light, porous, semirigid, elastic, gaseous, and/or spongy material that may provide a resistant force when compressed and may partially or fully recover its uncompressed shape when the compressive force is removed. For example, in various embodiments, the flexible element 16 may comprise or may be formed of a foam rubber, polymeric foam, ceramic foam, or other foam; a rubber; and/or another material or materials. The flexible element 16 may also or alternatively be configured to provide the resistant force when compressed. For example, in various embodiments the flexible element 16 may be configured as a coil, leaf or other cantilevered arm, or other spring, or other like member, that comprises a metal, polymer, ceramic, and/or another material or materials. The flexible element 16 may have any of various masses.

The latch mating element 18 may be configured as desired, such as with one or more holes or other voids, ribs, teeth, protrusions, or other shapes. The latch mating element 18 may include one or more pieces, and may be separate from or integral with the housing 30, such as described herein. The latch mating element 18 may be configured to engage, receive, insert into, or otherwise mate with at least a portion of the magnetically actuable latch 12. For example, in an embodiment where the magnetically actuable latch 12 is a slender member with a rectangular shape of face, the latch mating element 18 may be configured with a void in which the latching portion 14 of the magnetically actuable latch 12 or a part thereof may be inserted into the locking position, as described herein. In an embodiment where the magnetically actuable latch 12 is toothed at its latching portion end 14A, the latch mating element 18 may be configured with ribs, notches, or juts that engage the teeth in the locking position.

The security tag 20 may be any detectable device or system, such as any security tag or label. For example, in various embodiments the security tag 20 may be any type of EAS tag (e.g., Radio Frequency (RF) tag, acousto-magnetic tag, and/or combinations thereof), Radio Frequency Identification (RFID) tag, smart tag, or other detectable anti-theft or other tag. The security tag 20 may be detectable by a corresponding detecting system or device, such as, depending on the type of security tag or label, an acousto-magnetic detector, electromagnetic detector, radio frequency detector, or other detector.

The housing 30, as partially shown in the embodiment of FIG. 1, may be any casing or other structure that partially or fully contains and/or surrounds, encloses, affixes to, interlocks with, or otherwise secures the locking mechanism 10 and security tag 20, and, when the locking mechanism 10 is in the locking position and the housing is thereby locked, an article. The housing 30 and locking mechanism 10 may thus cooperate to secure, or lock, the article to the housing 30, and thus the security device 2. The housing 30 may be configured as desired, and may be shaped based upon the shapes of the locking mechanism 10, security tag 20, and article for which it is designed to secure, such as described herein with respect to the embodiments of the housing 130. The housing 30 may include the latch mating element 18, which may be integral with the housing 30. The housing 30 may alternatively be configured to pair with the latch mating element 18. The housing 30 may comprise a polymer and/or another material or materials.

The components included in the security device 2 may be configured such that the security device 2 may lock to an article, such as described with respect to the security device embodiments below. The security tag 2 may be reusable or may be for one-time use.

FIGS. 1A-1D illustrate a perspective, top, front, and side view of the detacher 40 shown in FIG. 1, in accordance with one embodiment. The detacher 40 may be a device that includes and houses a magnet 42. The magnet 42 may be any type of magnet, such as any permanent magnet or electromagnet, or a combination thereof, for example. Regarding the security system 1, the detacher 40 may be employed with the security device 2 to unlock the security device 2 from an article. The detacher 40 may be positioned appropriately near the magnetically actuable latch 12 of the security device 2 to magnetically force the magnetically actuable latch 12 away from the locking position, thus allowing the housing 30 of the security device 2 to be removed from an article to which it may be locked.

In various embodiments, the detacher 40 may include different magnets 42. For example, the magnet 42 of the detacher 40 may be selected based upon the magnetic force needed to move the magnetically actuable latch 12 away from the locking position, thus unlocking the security device 2. This magnetic force may need to more than offset the forces opposing the movement. Such opposing forces may include, for example, the resistant force provided by the flexible element 16 when it is compressed by the magnetically actuable latch 12, frictional forces caused by the magnetically actuable latch 12 contacting the housing 30 and/or another element during movement, and other forces. In another embodiment, where a detacher 40 is intended to be used on various security devices having different configurations, a magnet 42 may be selected that is strong enough to unlock the security device requiring the strongest magnet to unlock it.

In one embodiment, the security device 2 may be configured for one-time use. For example, in one embodiment as shown in FIGS. 1E-1F, the magnetically actuable latch 12 of the security device 2 maybe positioned within a channel 3 as mated with the latch mating element 18 in the locking position. One or more leaf springs or other cantilevered arms, such as the cantilevered arms 4 and 5, are disposed in the channel 3 in a spring-loaded configuration.

For example, the cantilevered arm 4 may have an unloaded position as shown in FIG. 1E. The cantilevered arm 4 may be bent to a position with its side 4A adjacent the channel wall 3A, and thus spring-loaded. The magnetically actuable latch 12 may then be disposed in the channel 3 in the locking position adjacent its other side 4B, preventing the cantilevered arm 4 from moving and preserving its spring load. The cantilevered arm 5 may be similarly positioned. Where the magnetically actuable latch 12 is then moved out of the locking position by the detacher 40, the cantilevered arms 4 and 5 may no longer be constrained by the magnetically actuable latch 12 and may spring back or otherwise return to their unloaded positions. Where in these positions the cantilevered arms 4 and 5 extend into the channel 3 such that they may block the base portion 13 of the magnetically actuable latch 12 from moving past them, the magnetically actuable latch 12 may not be able to return to the locking position. Thus, any appended security device may no longer be able to lock.

In another embodiment, only one of the cantilevered arms 4 and 5 is included. In various other embodiments, other resilient elements, such as coils or other springs, rubbers, and foams, for example, may be employed within the channel 3 or other portion of the housing to prevent the appended security device from being used twice.

In another embodiment such as shown in FIGS. 1G-1J, the locking mechanism portion and housing portion may be configured such that after each instance the magnetically actuable latch 12 is moved out of the locking position, the magnetically actuable latch 12 may need to be reset to enable it to be repositioned in the locking position. For example, the magnetically actuable latch 12 may be disposed in a channel 6 with its base end 13A adjacent a recess 7. The recess 7 may be configured such that where the magnetically actuable latch 12 is biased out of the locking position, at least a portion of the magnetically actuable latch 12 falls or is otherwise urged into the recess 7. The recess may be delineated by a wall 8 that may restrict movement of the magnetically actuable latch 12 back toward the locking position. In this embodiment, the security device in which the magnetically actuable latch 12 is disposed may be “reset” for use, such as by employing a magnet that may move the magnetically actuable latch 12 out of the recess.

In another embodiment, a hook tag security device 102, such as described with respect to the embodiments of FIGS. 2-24B, may include a locking mechanism 110, which may be a magnetically actuable locking mechanism such as described herein, a security tag, such as the security tag 20 described with respect to FIG. 1, a housing 130, and a hooking element 186. The hook tag security device 102 may be configured to secure an article to it. The article may be, for example, in various embodiments, a pair of glasses, a shoe, a piece of jewelry, a ring, a fishing reel and/or rod, or a whole or portion of another item.

FIGS. 2-7 illustrate various perspectives views of a hook tag security device 102, in accordance with one embodiment, and may be referred to where a corresponding element thereof is discussed. The hook tag security device 102 in this embodiment includes a housing 130 that may include various portions, such as a bottom housing 150 and top housing 170, such as described below. Each portion may comprise one or more materials, such as plastics and metals, and the portions may comprise the same or different materials, or a combination thereof.

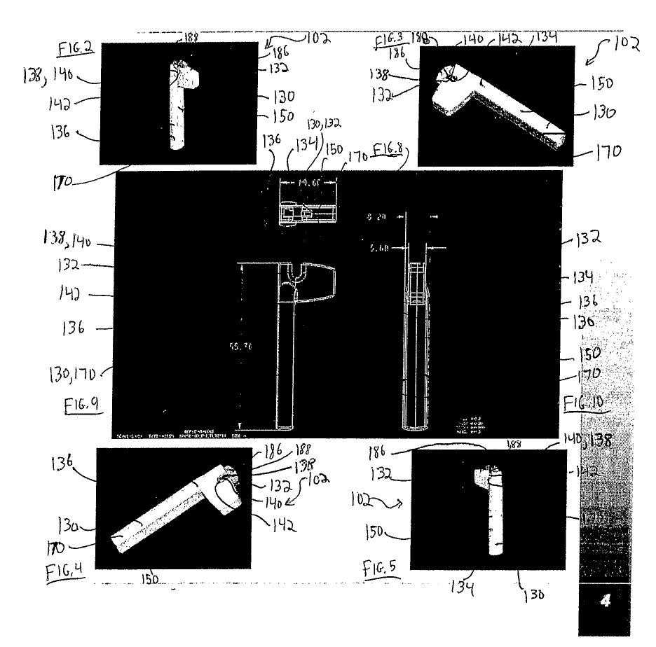

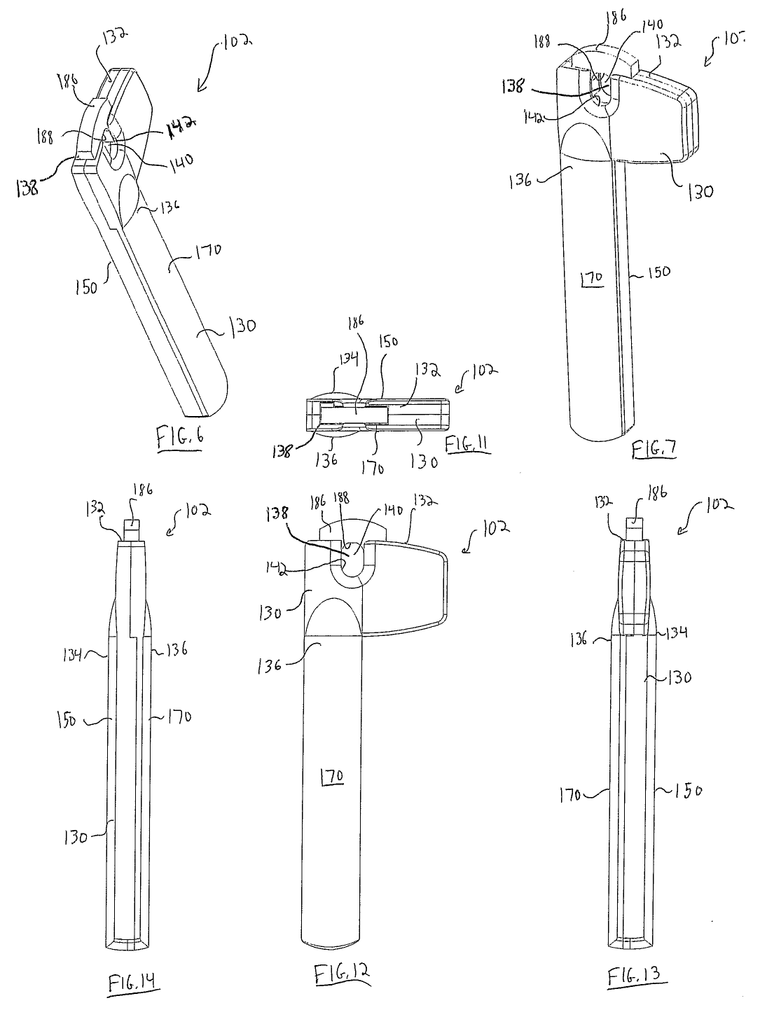

FIGS. 8-10, as well as FIGS. 11-13, illustrate a top view, front view, and right side view, respectively, of a hook tag security device 102, in accordance with one embodiment, although FIGS. 8-10 do not show a hooking element, such as the hooking element 186 embodiment described below. FIG. 14 illustrates a left side view of a hook tag security device 102, in accordance with this embodiment.

In one embodiment, the housing 130, and thus the hook tag security device 102, may be at least partially “L” shaped, as shown from the front views of FIGS. 9 and 12.

The housing 130 may have a top outer face 132 that is at least partially rectangular but with outwardly bowed sides 134 and 136, as viewed from the top view of FIGS. 8 and 11. The top outer face 132 may include a recess 138 that may include an article receiving portion 140, which may be delineated by an article receiving wall 142, and which may be “U” shaped in one embodiment as shown from the front views of FIGS. 9 and 12. As described below, the article receiving portion 140 may be shaped to receive a portion of an article to be secured to the hook tag security device 102, and may also be shaped to receive a portion of the hooking element 186. The recess 138 may also include a hooking element receiving portion 144, which may shaped be at least partially rectangular, or circular or otherwise rounded, for example, and comprise a portion of, or overlap, the article receiving wall 142, as viewed from the top views of FIGS. 8 and 10. However, the recess 138, and its article receiving portion 140 and hooking element receiving portion 144, may be otherwise shaped in various embodiments, such as described below, for example.

In an embodiment, the housing 130 may have the approximate outer dimensions S1, S2, and S3 of 8.1 mm, 19.6 mm, 12.93 mm, respectively, and S4 of 55.38 or 55.76 mm. The housing 130 may have a slender thickness. In one embodiment, the housing 130 has approximate thicknesses T1 of 4.29 or 5.50 mm and T2 of 6 or 8.2 mm. However, in various embodiments, the housing 130, and components thereof, may be sized and dimensioned as desired, such as described with respect to the housing 30 of the FIG. 1 embodiment, for example. The housing 130 may be configured, such as described herein, to secure the security tag and an article, and thus may lock the hook tag security device 102 to the article, such as described below.

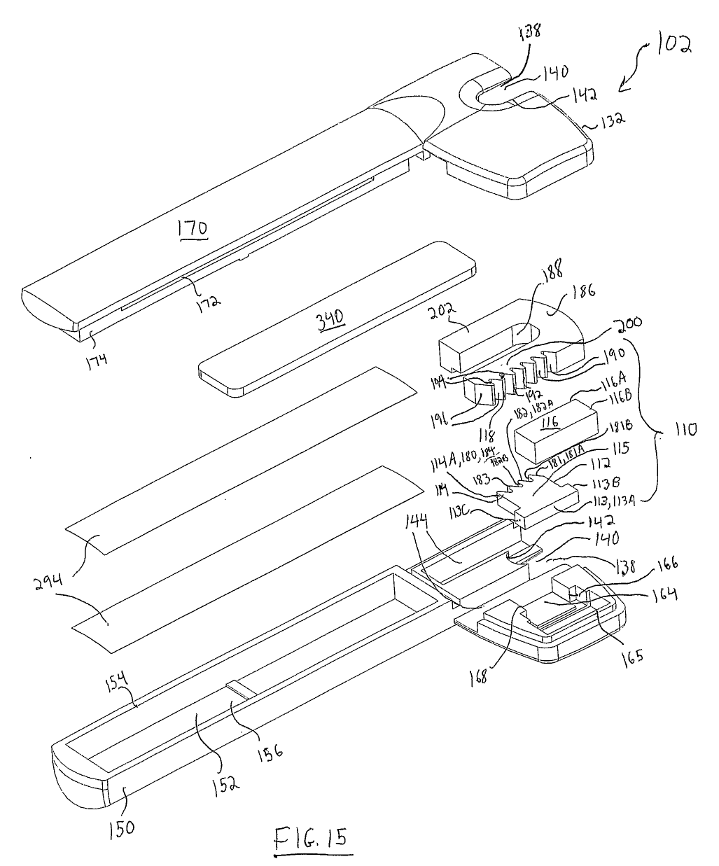

FIG. 15 illustrates an exploded view of a hook tag security device 102, showing elements that may be included therewith, in accordance with one embodiment. This figure may be referred to where a corresponding element thereof is discussed.

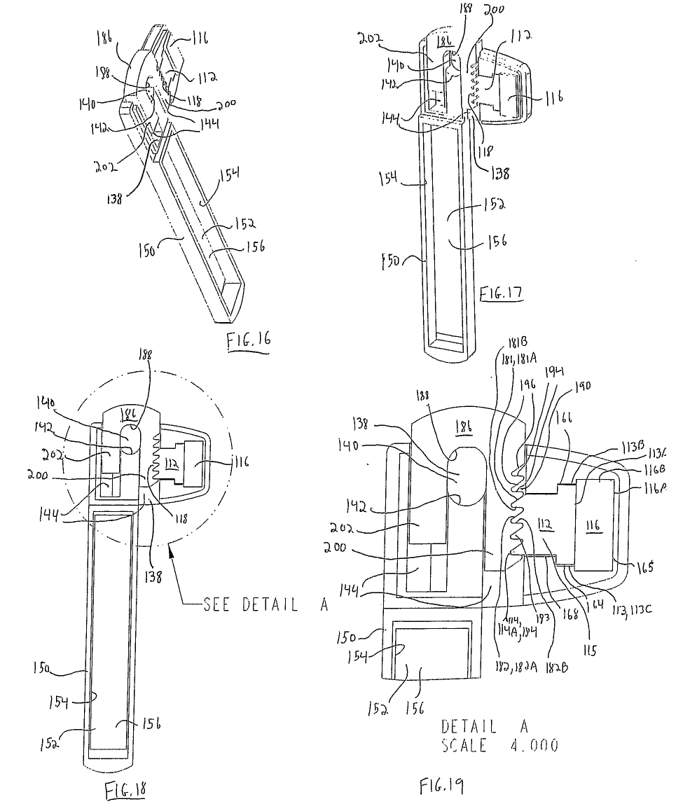

FIGS. 16-19 illustrate a perspective, perspective, front, and front view, respectively, of a locking mechanism 110, bottom housing 150 (only a portion of which is shown in FIG. 19), and hooking element 186 of a hook tag security device 102, in accordance with one embodiment. The portion of the hook tag security device 102 shown in FIG. 19 includes a more detailed referencing than FIGS. 15-18 concerning portions of the magnetically actuable latch 112, flexible element 116, and latch mating element 118.

Referring to FIGS. 15-19, the locking mechanism 110 may include a magnetically actuable latch 112 or portion thereof, a flexible element 116, and a latch mating element 118. The magnetically actuable latch 112 may comprise a magnetic material, and may comprise one or more materials such as described with respect to the magnetically actuable latch 12 of FIG. 1. The magnetically actuable latch 112 may include a base portion 113, which may include a base portion end 113A and base portion side surfaces 113B and 113C; a latching portion 114, which may include a latching portion end 114A; and a central portion 115.

The magnetically actuable latch 112 may be shaped at least partially like a “T”. Thus, the base portion side surfaces 113B and 113C may be parallel and each may be at least substantially straight, and the width of the base portion 113, which may be the distance between base portion side surfaces 113B and 113C, may be wider than the other widths of the magnetically actuable latch 112. The base portion end 113A may be flat and may be substantially perpendicular to the base portion side surfaces 113B and 113C. The magnetically actuable latch 112 may be configured with a slender thickness. However, the magnetically actuable latch 112 may be otherwise configured in various embodiments, such as described herein with respect to the magnetically actuable latch 12 shown in FIG. 1.

The magnetically actuable latch 112 may include one or more protrusions 180. The protrusions 180 may be positioned at least partially in the latch portion 114 of the magnetically actuable latch 112, and may have ends at the latching portion end 114A.

In one embodiment, the protrusions 180 may be one or more teeth, such as four teeth 181-184, for example. The four teeth 181-184 may have similar or substantially the same shape in one embodiment. For example, sides 181A-182A and 181B-182B may be relatively angled such that they meet at, or terminate near, the tooth ends 181C-182C, respectively. The tooth ends 181C-182C may thus be pointed or rounded off, or may otherwise, in various other embodiments, be shaped to mate with the latch mating element 118 described below.

The sides 181A-182A may be at least substantially parallel, as may be the sides 181B-182B. The sides 181A-182A may be angled with respect to the base portion side surfaces 113B-113C of the base portion 113 and/or the one or both of the corresponding sides of the latching portion 114 and central portion 115 of the magnetically actuable latch 112. The sides 181B-182B may be substantially parallel or less angled (than the sides 181A-182A) with respect to the base portion side surfaces 113B-113C of the base portion 113 and the corresponding sides of the latching portion 114 and central portion 115. These examples regarding teeth 181-182 may further apply to teeth 183-184 and any other teeth that the protrusions 180 comprise. The teeth 181-184 may be equally spaced or non-uniformly spaced.

However, the one or more protrusions 180 may comprise other configurations. For example, the one or more protrusions 180 may comprise one or more ribs, notches, jags, points, curves, or voids, for example. The one or more protrusions 180 may be positioned at least partially on the latching portion 114 of the latch and may comprise the latching portion end 114A. The one or more protrusions 180 may be configured to mate with the latch mating element 118 in the locking position, such as described below.

The magnetically actuable latch 112 may be otherwise configured in various embodiments, such as described herein with respect to the magnetically actuable latch 12 shown in FIG. 1.

The flexible element 116 may comprise or be formed of a flexible material, and may include a material or materials such as described herein with respect to the flexible element 16 shown in FIG. 1. The flexible element 116, in one embodiment, may be configured with a substantially cuboidal shape such that its side 116A is wider than its side 116B, or may have another shape. In various other embodiments, the flexible element 116 may be configured as, and comprise one or more materials of, a coil or other spring or like member, such as described above with respect to the flexible element 16 of FIG. 1.

In one embodiment such as described below, the latch mating element 118 may be integral with, and thus included in, a hooking element 186, and may be separate from the housing 130. In this embodiment, the latch mating element 118 may include one or more voids 190. In one embodiment, the magnetically actuable latch 112 may mate with the latch mating element 118 in the locking position when the one or more teeth or other protrusions 180 extend into the one or more voids 190.

The one or more voids 190 may be delineated by one or more juts 192, which may be protrusions such as described herein with respect to the protrusions 180. The one or more juts 192 may each comprise jut sides 194 and 196, which may be non-parallel in one embodiment. For example, in one embodiment, the jut sides 194 may be substantially perpendicular or close to perpendicular to the tangential direction along the length of the latch mating element 118, whereas the jut sides 196 may have an angle that is acute, such as 45 degrees for example, relative to this length. Such a configuration may facilitate pushing, pulling, or otherwise moving the latch mating element 118, and thus the integral hooking element 186 in an embodiment where these components are integral, through the recess 138 in one direction but not the other, opposing direction, such as described below.

However, the latch mating element 118 may be otherwise configured, such as with one or more ribs, notches, jags, points, curves, or voids, for example, to mate with the magnetically actuable latch 112 in the locking position. For example, in one embodiment, the latch mating element 118 may be configured with one or more voids 190 shaped like or somewhat like that of the one or more protrusions 180 of the magnetically actuable latch 112. Thus, at least one void 190 may receive at least one protrusion 180 or a portion thereof, which may prevent or inhibit movement of the latch mating element 118 out of the recess 138.

The latch mating element 118, and possibly also the hooking element 186 in an embodiment in which the latch mating element 118 is included therewith, may comprise one or more of various materials and configurations in various other embodiments, including, for example, any plastic or metal or a combination thereof, in any configuration. For example, in one embodiment, the latch mating element 118 and hooking element 186 comprise a penetrable material such as rubber or a soft plastic, and the magnetically actuable latch 112 may include protrusions 180, such as pointed teeth. Such protrusions may dig into the latch mating element 118 where the magnetically actuable latch 112 is in the locking position and the latch mating element 118 is pulled with a force for directing it out of the recess 138, and thus, the housing 130. In another embodiment, the latch mating element 118 and possibly also the hooking element 186 are configured with an outer penetrable material and inner reinforcing material such as a metal.

The bottom housing 150 of the housing 130 may be configured such that the magnetically actuable latch 112 and flexible element 116 of the locking mechanism 110 may be adjacently disposed therein. Thus, the base portion end 113A of the magnetically actuable latch 112 may be positioned near or in abutment with the flexible element 116. With such a configuration, the movement of the magnetically actuable latch 112 and flexible element 116 may be restricted in one or more directions.

For example, the bottom housing 150 may include a channel end wall 165, channel walls 166 and 168, and a channel 164 delineated by channel walls 166 and 168 and bounded by the channel end wall 165. The channel walls 166 and 168 may include portions substantially parallel to each other, and may be positioned close to or in contact with the magnetically actuable latch 112 at the base portion side surfaces 113B and 113C, respectively, and at the sides of the central and latching portions 115 and 114, thereby restricting the movement of the magnetically actuable latch 112 to movement along the channel 164, which may be movement in a substantially linear direction, for example.

In various other embodiments, the magnetically actuable latch 112 may move in a rotational, combination rotational/linear direction, or any other direction or directions. In these various other embodiments, one or more of the channel 164, flexible element 116, and latch mating element 118 may be contoured, shaped, or otherwise configured to guide the magnetically actuable latch 112 in the direction or directions.

The flexible element 116 may be positioned adjacent the channel end wall 165 such that where the magnetically actuable latch 112 is forced away from the locking position and against the flexible element 116, the flexible element 116 may compress by the force of the magnetically actuable latch 112 and the resistant force of the channel end wall 165. The flexible element 116 may provide a resistant force to such compression, against such movement of the magnetically actuable latch 112.

As described above, in each of various embodiments the magnetically actuable latch 112 may be configured with another shape, in which case the channel 164, and thus the channel walls 166 and 168, may be configured to accommodate such a magnetically actuable latch 112 and possibly restrict the movement of the magnetically actuable latch 112 in one or more directions. In each of these embodiments, the flexible element 116 may be configured to fit within the channel 164.

Thus, the flexible element 116 of the locking mechanism 110 may bias the magnetically actuable latch 112 into the locking position where the teeth 181-184 or other protrusions 180 of the magnetically actuable latch 112 may engage one or more of the juts 192 of the latch mating element 118 portion disposed in the recess 138 of the housing 130. Such a configuration may prevent or provide resistance to movement of the latch mating element 118 out of the recess 138 and thus the housing 130.

For example, in one embodiment, where a tooth 181 of the magnetically actuable latch 112 is disposed in the locking position between two juts 192, the adjacent jut side 194 may be substantially parallel or have a small angle relative to the tooth side 181B. But the jut side 194 and tooth side 181B maybe substantially perpendicular or close to perpendicular to the direction in which the latch mating element 118 moves through the recess 138 as constrained by the walls of the hooking element receiving portion 144 and/or other walls of the recess 138. Thus, where a force is applied to the latch mating element 118 to pull it out of the recess 138, the latch mating element 118 may move until the jut side 194 and tooth side 181B contact and exert opposing substantially or close to normal forces on each other. In such case, the latch mating element 118 may be prevented or inhibited from being pulled out of the recess 138.

However, in one embodiment, such a configuration may not prevent or may provide less resistance to movement of the latch mating element 118 into the recess 138 of the housing 130. Thus, the tooth side 181A and adjacent jut side 196 maybe angled relative to the direction of movement of the latch mating element 118 in the recess 138. Where a force is applied to the latch mating element 118 to push it further into the recess 138, the latch mating element 118 may move until the jut side 196 and tooth side 181A contact. In such case, the jut side 196 and tooth side 181A may exert much lower opposing normal forces than that of the jut side 194 and tooth side 181B as described in the above paragraph. If, for example, the outer material of the latch mating element 118 is deformable as discussed herein, and/or if the magnetically actuable latch 112 is slidable within the channel 164, the latch mating element 118 may be moved. Movement may be made by a force greater than any normal force, friction force caused by the jut side 196 and tooth side 181A sliding against each other, compressive force the jut 192 provides from its deformation, and/or any other opposing forces.

This force to move the latch mating element 118 into or further into the recess 138 may be lower, and may be much lower, than the force to move the latch mating element 118 out of the recess 138. Thus, for example, this lower force may be manageably exerted, in one embodiment, by a person such that the person may tighten the latch mating element 118 around a portion of an article such that the article is positioned in the article receiving portion 140 of the recess 138, between the article receiving wall 142 of the housing 130 and a securing wall 188 of the hooking element 186. In embodiments where the magnetically actuable latch 112 has multiple protrusions 180 and the latch mating element 118 has multiple juts 192, the opposing forces caused by all protrusions 180 and juts 192 in contact may need to be overcome. This force may still be such that a person can manageably force the hooking element 186 with the latch mating element 118 further into the recess 138.

The bottom housing 150 of the housing 130 may be further or alternatively configured to receive a security tag, or portion thereof, and a top housing 170. In one embodiment, the bottom housing 150 may include a security tag receptacle 152 comprising a security tag receptacle wall 154 and a void 156 delineated by the security tag receptacle wall 154. A security tag, or portion thereof, may be disposed within the void 156, and thus in the security tag receptacle 152.

The security tag receptacle 152 of the bottom housing 150 may also be configured to receive a portion of the top housing 170. For example, the security tag receptacle wall 154 and void 156 may be shaped to receive a mating protrusion 174 of the top housing 170. The bottom housing 150 may be alternatively configured based upon the configuration of the top housing 170, or otherwise configured to receive the top housing 170. The top housing 170 may be secured to the bottom housing 150 by welding, fusing, gluing, snap-fit (such as where the bottom housing 150 and top housing 170 are configured with mating protrusions and voids, for example), interference fit, and/or by other securing means.

The top housing 170 may be configured with an outer shape similar to that of a mirror image of the bottom housing 150. The bottom housing 150 and top housing 170 may together form the article receiving wall 142 of the article receiving portion of the recess 138, and may otherwise form the recess 138.

In one embodiment, the security tag includes one or more linear amorphous resonators 294 and possibly also a magnetized bias 340. The one or more linear amorphous resonators 294 and the magnetized bias 340 may be disposed in the security tag receptacle 152. In an embodiment such as shown in exploded view of FIG. 15, the security tag may include two linear amorphous resonators 294. In another embodiment, the top housing 170 may include a slot 172 within which the magnetized bias 340 may be positioned.

In an embodiment, the hooking element 186 comprises two arms 200 and 202. In an embodiment, the arm 200 of the hooking element 186 includes a latch mating element 118, such as described above. The arms 200 and 202 may be substantially parallel and of unequal length, or may be otherwise configured.

For example, in an embodiment, the hooking element 186 may be shaped such that its arms 200 and 202 may slide into or otherwise fit in the spaces of the hooking element receiving portion 144, which may comprise two shafts that may be parallel and may be shaped to each receive one of the arms 200 and 202, such as shown in FIG. 19. In this embodiment, the latch mating element 118 of the arm 200 may engage the magnetically actuable latch 112 as the arm 200 is moved within a shaft of the hooking element receiving portion 144. The geometry and/or materials of the latch mating element 118 and magnetically actuable latch 112 may be such that, as described above, the latch mating element 118, and thus the hooking element 186, can be manageably pushed in a direction further into the recess 138, but is prevented from or restricted in movement out of the recess 138.

For example, in an embodiment, the hooking element 186 may be forced into the recess 138 such that voids 190 of the latch mating element 118 engage the teeth 181-184 of the magnetically actuable latch 112 in the locking position, such as shown in FIG. 19, but subsequent movement of the hooking element 186 in a direction out of the recess 138, and thus out of the locking position, is prevented or inhibited.

In an embodiment, the hooking element 186 having a latch mating element 118 may be at least partially “U” shaped, such as shown in, e.g., FIG. 19. In this embodiment, the hooking element 186 may be pushed into the recess 138 to enclose the article receiving portion 140 between the securing wall 188 of the hooking element 186 and the article receiving wall 142 of the housing 130, thus securing any article positioned at least partially therein. The article may thus be secured by the hooking element 186 as coupled with the housing 130 when the latch mating element 118 mates with the magnetically actuable latch 112 in the locked position. In an embodiment, the hooking element 186 may be pushed into the recess 138 and tightened around a portion of an article disposed within the article receiving portion 140 to further facilitate securing the article to the hook tag security device 102. In other embodiments, the hooking element 186 may not be tightened around the article.

In another embodiment, the hooking element 186 may be shaped and sized to be integral or otherwise coupled with the housing 130 or another portion of the hook tag security device 102. In this embodiment, the hooking element 186 may be movably secured to the housing. The hooking element may thus move between positions in which it alternatively exposes and encloses the article receiving portion 140 of the recess 138 of the housing 130, yet may always remain coupled with the housing 130.

For example, in an embodiment, the hooking element 186 may be hingedly or otherwise rotatably secured to the housing 130 at an end of the arm 202, such that the hooking element 186 may rotate with respect to the housing 130. The arm 202 end and the housing 130 may share a flexible end or be affixed by pin, for example, such that the hooking element 186 may be rotated about that end or pinned portion. The hooking element 186 may thus be rotated to enclose the article receiving portion 140 of the recess 138, and any article at least partially disposed therein. In an embodiment where the hooking element 186 includes an arm 200 having a latch mating element 118, the hooking element 186 may thus be rotated over the article until its latch mating element 118 engages the magnetically actuable latch 112 in the locking position, thus securing the article.

In another embodiment, such coupling between the hooking element 186 and housing 130 may be by way of a stopper at an end of one or both arms 200 and 202. The stopper may be a wider portion of one or both of the arms 200 and 202. In this embodiment, the hooking element 186 may be pulled out of the locking position to expose the article receiving portion 140, but may have its stopper impeded by a narrow part of the hooking element receiving portion 144, such as near the top outer face 132 of the housing 130. Thus, the hooking element 186 will be impeded from complete removal from the housing 130.

In various other embodiments, the hooking element 186 and housing 130 may be otherwise coupled such that they remain coupled whether “locked” to each other. For example, the hooking element 186 may be coupled such that it may both slide and rotate to expose the article receiving portion 140 without being completely removed from the housing 130.

FIGS. 20-24B illustrate various embodiments of the hook tag security device 102, as secured to various articles. In each embodiment, an article is positioned partially within the article receiving portion 140 of the recess 138. The hooking element 186 has been positioned to enclose the article receiving portion 140 to thereby secure the article, such as described above.

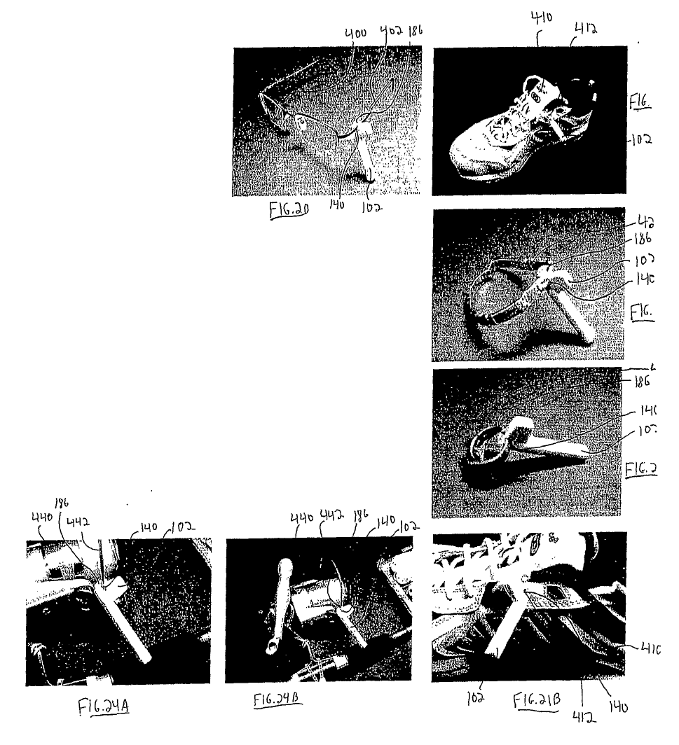

FIG. 20 shows the hook tag security device 102 securing a pair of eyeglasses 400 by an eyeglasses leg 402. FIGS. 21A-21B show the hook tag security device 102 securing a shoe 410 by a shoelace hole 412. FIG. 22 shows the hook tag security device 102 securing piece of jewelry 420. FIG. 23 shows the hook tag security device 102 securing a ring 430. FIGS. 24A-24B show the hook tag security device 102 securing a fishing reel and attached rod by a bail wire 442.

In one embodiment, a hook tag security device system includes the hook tag security device 102 and a detacher, such as the detacher 40 described herein with respect to FIG. 1. Where the detacher 40 is placed near the magnetically actuable latch 112 of the hook tag security device 102 such that the flexible element 116 is positioned between the detacher 40 and magnetically actuable latch 112, the detacher 40 may magnetically force the magnetically actuable latch 112 out of the locking position and against the flexible element 116. If the magnetic force is greater than the compressive force of the flexible element 116 and any other forces resisting such movement of the magnetically actuable latch 112, the magnetically actuable latch 112 may move out of the locking position. In such case, the hooking element 186 may not be blocked from being pulled or otherwise removed from the housing 130, and may thus be removed from the rest of the hook tag security device 102, exposing the recess 138 and thus the article receiving portion 140 of the recess 138. Where an article was disposed at least partially in the article receiving portion 140, the article may be freely removed from the hook tag security device 102.

In an embodiment where the hooking element 186 is integral with or otherwise coupled with the housing 130, such as described above, the hooking element 186 is moved out of obstruction from the article when the hook tag security device 102 is unlocked. Thus exposed, the article may be removed from the article receiving portion 140 of the recess 138, and thus the hook tag security device 102.

Because no part of the hook tag security device 102, in one embodiment with either a separate hooking element 186 or one integral or otherwise coupled with the housing 130, may be broken to unlock it, the hook tag security device 102 may be reusable. In another embodiment, the hook tag security device 102 employs a magnetically actuable latch 112 or security tag that is for one-time use or is resettable.

While certain features of the embodiments have been illustrated as described herein, many modifications, substitutions, changes and equivalents will now occur to those skilled in the art. It is, therefore, to be understood that the appended claims are intended to cover all such modifications and changes as fall within the scope of the embodiments.

1. A security device for an article, comprising:
a magnetically actuable locking mechanism;
a security tag;
a hooking element; and
a housing to couple with the hooking element to secure the article, the security tag and magnetically actuable locking mechanism coupled with the housing.

2. The security device of claim 1, wherein the magnetically actuable locking mechanism comprises a magnetically actuable latch, a flexible element, and a latch mating element.

3. The security device of claim 1, wherein the flexible element and the magnetically actuable latch are combined as a single piece.

4. The security device of claim 1, wherein the housing further comprises a channel, and wherein the magnetically actuable latch and flexible element are at least partially disposed in the channel.

5. The security device of claim 1, wherein the latch mating element is integral with the hooking element.

6. The security device of claim 5, wherein the housing comprises a recess, and wherein the hooking element is to couple with the housing by being positioned in the recess such that the latch mating element engages the magnetically actuable latch in the locking position.

7. The security device of claim 1, wherein the latch mating element comprises at least one void, wherein the flexible element is positioned adjacent the magnetically actuable latch and biases the magnetically actuable latch toward a locking position in which at least part of the magnetically actuable latch extends into the void.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. The security device of 26, security device further comprising a recess to receive the article, and wherein the hooking element is movably secured to the housing such that the hooking element may move between a position in which the hooking element encloses the recess and a position in which the hooking element exposes the recess.

28. A security device for an article, comprising:
a magnetically actuable locking mechanism;
a security tag;
a hooking element; and
a housing, the security tag and magnetically actuable locking mechanism coupled with the housing, the housing comprising a recess to receive the hooking element and to thereby enclose a portion of the recess, the enclosed portion of the recess to secure an article to the housing.

29. (canceled)

30. The security device of claim 28, wherein the magnetically actuable locking mechanism comprises a latch mating element, and wherein the hooking element is integral with the latch mating element.

31. The security device of claim 28, wherein the hooking element comprises an arm, the arm comprising a latch mating element.

32. The security device of claim 31, wherein the recess comprises a shaft to receive the arm of the hooking element.

33. The security device of claim 32, wherein the hooking element comprises a second arm, and wherein the recess comprises another shaft to receive the second arm.

34. The security device of claim 28, wherein the security tag comprises one or more linear amorphous resonators and a magnetized bias.

35. The security device of claim 28, wherein the magnetically actuable locking mechanism comprises a magnetically actuable latch, a flexible element, and a latch mating element.

36. The security device of claim 28, wherein the hooking element is rotatably secured to the housing.

37. The security device of claim 28, wherein the hooking element is integral with the housing.

38. The security device of claim 28, wherein the hooking element is movably secured to the housing such that the hooking element may move between a position in which the hooking element encloses the portion of the recess and a position in which the hooking element exposes the portion of the recess.

39. The security device of 38, wherein the hooking element is movably secured to the housing such that the hooking element may move between a position in which the hooking element encloses the portion of the recess and a position in which the hooking element exposes the portion of the recess.

40. A security device system, comprising:
a security device comprising a housing, a magnetically actuable locking mechanism disposed in the housing, and a hooking element to couple with the housing to secure an article; and
a detacher to unlock the security device, the detacher comprising a magnet.

39. (canceled)

40. (canceled)

41. (canceled)
